(19) United States
(12) Patent Application Publication
(10) Pub. No.: US 2025/0310589 A1
(43) Pub. Date: Oct. 2, 2025

(54) SYSTEM FOR PROVIDING A REMOTE EXPERIENCE REPLICATING A LIVE SPORTING EVENT

(71) Applicant: Allen D Hertz, Boca Raton, FL (US)

(72) Inventor: Allen D Hertz, Boca Raton, FL (US)

(21) Appl. No.: 19/090,062

(22) Filed: Mar. 25, 2025

Related U.S. Application Data
(60) Provisional application No. 63/569,980, filed on Mar. 26, 2024.
(60) Provisional application No. 63/669,051, filed on Jul. 9, 2024.

(51) Int. Cl. H04N 21/414; H04N 21/218; H04N 21/2187

(52) U.S. Cl. CPC H04N 21/41415; H04N 21/21805; H04N 21/2187

(57) ABSTRACT

A system for replicating an entire view of a live event at a first venue, such as a sporting event occurring, by presenting audio-video of the entire event at a replay venue. The system employs at least one camera arranged to capture video including an entire view of the live event, collectively the video captured by the at least one camera includes the entire field of the live event in each frame of the video. Multiple cameras acquire audio-video which is replayed using an audio-video playback system replicating the experience of the event at the replay venue. The playback system can be installed at any suitable replay venue (i.e. an away team venue).

### CROSS REFERENCE TO RELATED APPLICATIONS

This application is a Non-Provisional Application claiming the benefit to:
a. U.S. Provisional Patent Application Ser. No. 63/569,980, filed on Mar. 26, 2024; and
b. U.S. Provisional Patent Application Ser. No. 63/669,051, filed on Jul. 9, 2024;
c. each of which are incorporated herewith by reference in their entireties.

### FIELD OF THE INVENTION

The present invention relates to a system which captures actions in a sporting event and presents the actions at a different location, wherein the reproduction of the actions in the sporting event is presented allowing the fan to view the sporting event as if the fan was at the actual game. More specifically, the system captures the actions in the sporting event using any suitable method enabling replication of the entire playing field exclusive of any specific focused field of view.

### BACKGROUND OF THE INVENTION

Broadcasting of sporting events is determined by a broadcasting company. The broadcasting is commonly limited to a small portion of the game, usually focusing on play near the game piece (ball, puck, etc.). This limits the exposure of the other activities on the playing field to the viewer or fan. Generically, the current viewing systems do not provide a full experience of being at an event.

Sporting event promoters and others host watch parties. The watch party is commonly hosted by a local venue, such as a bar, a sports bar, and the like. Watch parties are limited to showing the broadcast version of the sporting event on television sets. The displayed sporting event is the television broadcast, again, presenting a view usually focusing on play near the game piece (ball, puck, etc.). Team mascots, dancers, cheerleaders, local hosts, and the like usually attend these watch parties. The watch parties may or may not require a cover charge. Team merchandise may be offered for sale at the watch parties. Food and drinks are commonly offered for sale at the watch parties. Seating can be difficult. The entire aura differs from the aura when attending an actual game. Particularly when watching the game as a season ticket holder when you are surrounded by the same group of people throughout the season.

The television broadcast is also made available to private parties via broadcast television, via cable television, via streaming services, via subscription services, and the like. Again, the limitation of these distribution methods are that each presents the audio and video as captured by the respective video crew of the broadcasting company, where the captured video is close up and commonly following the game piece. This limits the end viewer's ability to watch the entire sporting event exclusive of any limitations imposed by the limited video captured by the video crew.

Current televisions or other monitors have a ratio that is less than ideal for viewing a complete sporting event (live) playing field.

What is desired is a system that can be installed at any suitable sporting event where the system would capture audio and video of the entire sporting event in a manner enabling the entire sporting event to be rebroadcast providing the spectator with an experience that replicates being at the actual sporting event. This would enable the viewer to watch any portion of the sporting event that they desire at any point in time, wherein the displayed video would be exclusive of any reduced view of the playing field. Limited video captured by the broadcasting company can be presented on a separate display, such as a Jumbotron, enabling close-up viewing, replays, etc, all while viewing the sporting event in its entireties.

What is desired is an apparatus or mesh of apparatuses (monitors) enabling a correct ratio for viewing the entire sporting event (live) playing field at a remote location.

### SUMMARY OF THE INVENTION

The present invention overcomes the deficiencies of the known art and the problems that remain unsolved by providing a system and a method of use which acquires one or more videos which collectively present a single image of a sporting event being played at a playing field. The collected image is then rebroadcast on a video screen that has viewing parameters that are suitable to replicate the entire field of play of the sporting event, such as aspect ratio, screen pitch, manifold geometry, and the like. The video screen can be installed at an away team's playing venue, on an away team's field of play, at a third party's playing venue, on a third party's field of play, at a viewer's residence, at a commercial establishment, or any other suitable location. The video can be viewed using virtual reality glasses, where the user would rotate their head to change the viewed portion of the entire video.

In accordance with one embodiment of the present invention, the invention consists of:
at least one camera arranged to capture video including an entire field of play of a sporting event, collectively the video captured by the at least one camera includes the entire field of play of the sporting event in each frame of the video; and
a video display system that is configured to display the entire field of play of the sporting event.

In accordance with a more enhanced embodiment of the present invention, the invention consists of:
at least one camera arranged to capture video including at least a portion of a field of play of an event being held in a first venue; and
a video display system configured to display the entire field of play of the sporting event on a surface substantially coextensive with a second entire field of play,
wherein the second field of play is substantially similar in size and shape to the field of play and situated within a second venue, and
wherein a spectator present during display of video on the video display system at the second venue is able to view a live sporting event occurring in the first field of play at the same relative position relative to their location in the second venue.

In a second aspect, the at least one camera is installed at the venue of the sporting event.

In another aspect, the at least one camera installed at the venue of the sporting event remains fixed throughout the play of the sporting event.

In another aspect, the sporting event can be one of: a football game, a soccer match, a rugby match, a baseball game, a softball game, a basketball game, a hockey game (ice, roller, field, etc.), a lacrosse game, a tennis match, a cricket game, a volleyball game, a pickleball game, a badminton game, a polo match, and the like.

In yet another aspect, the at least one camera is located at a distance from the field of play enabling capture of at least a portion of the field of play.

In yet another aspect, the at least one camera is located at a distance from a boundary of the field of play enabling capture of at least a portion of the field of play.

In yet another aspect, the at least one camera is located at a distance from a boundary of the field of play increasing a field of view of the camera, thus enabling capture of at least a portion of the field of play.

In yet another aspect, the at least one camera is located in a grandstand at the venue of the sporting event, the camera location increasing a field of view of the camera, thus enabling capture of at least a portion of the field of play.

In yet another aspect, the at least one camera is located in a grandstand at the venue of the sporting event at a location that avoids interference with the fans, the camera location increasing a field of view of the camera, thus enabling capture of at least a portion of the field of play.

In yet another aspect, the at least one camera includes a plurality of cameras, where each camera is directed perpendicularly towards the field of play.

In yet another aspect, the at least one camera includes a plurality of cameras, where each camera is directed perpendicularly towards the field of play along each of the two longer boundaries.

In yet another aspect, the at least one camera includes a plurality of cameras, wherein a first portion of the camera are directed perpendicularly towards the field of play along each of the two longer boundaries and a second portion of the camera are directed perpendicularly towards the field of play along each of the two shorter, end boundaries.

In yet another aspect, the at least one camera includes a plurality of cameras, wherein a first portion of the plurality of cameras are directed perpendicularly towards the field of play along each of the two longer boundaries of the playing field, a second portion of the plurality of cameras are directed perpendicularly towards the field of play along each of the two shorter, end boundaries of the playing field, and a third portion of the plurality of cameras are directed radially towards the field of play respective to each of the rounded corner portions of the boundary of the playing field.

In yet another aspect, captured video of the sporting event can be synchronized at the outputs such that when played back they form a contiguous image of the sporting event across the entire field of play.

In yet another aspect, captured video of the sporting event can include markers to aid in synchronizing at the output videos such that when played back they form a contiguous image of the sporting event across the entire field of play.

In yet another aspect, captured video of the sporting event can include markers to aid in synchronizing at the output videos such that when played back they form a contiguous image of the sporting event across the entire field of play, wherein the markers are time stamps.

In yet another aspect, video captured of the sporting event is stitched together to generate a single video of the sporting event across the entire field of play.

In yet another aspect, video captured of the sporting event is cropped and stitched together to generate a single video of the sporting event across the entire field of play.

In yet another aspect, video captured of the sporting event is cropped to size for display upon a predetermined respective portion of the video display.

In yet another aspect, the display can include any of the following:
a projector,
a canvas screen,
a upwardly arch-shaped screen,
a upwardly arch-shaped display,
a dome shaped screen,
a dome shaped display,
a stadium shaped canvas screen,
a stadium shaped display,
a liquid crystal display, and
a light emitting diode display.

In yet another aspect, the video display can be a liquid crystal display.

In yet another aspect, the video display can include a plurality of liquid crystal displays.

In yet another aspect, the video display can be a projection video screen.

In yet another aspect, the video display can be an array of colored light emitting diode display.

In yet another aspect, the video display can include a plurality of array of colored light emitting diode displays.

In yet another aspect, the video display is deployed in a sporting event venue.

In yet another aspect, the video display is deployed in a sporting event venue, an image of the video display being oriented towards grandstands along one of a larger side of the field of play.

In yet another aspect, the pair of video displays is deployed in a sporting event venue, an image of a first video display of the pair of video displays being oriented towards grandstands along a first of a larger side of the field of play and an image of a second video display of the pair of video displays being oriented towards grandstands along a second of a larger side of the field of play.

In yet another aspect, each video display is deployed in wherein a spectator is able to view an object in the first field of play as if they were the same position in the actual location of the sporting event relative to their actual location in the replicating location.

In yet another aspect, the rendered display replicates the entire sporting event enabling the spectator to capture an experience as if the spectator was at the actual sporting event.

In yet another aspect, the video display is deployed on a playing field of a sporting event venue.

In yet another aspect, the video display is deployed on a playing field of a sporting event venue, the video display extending substantially from one end of the field of play to the second, opposite end of the field of play.

In yet another aspect, the video display is deployed on a playing field of a sporting event venue, the video display extending in an elongated direction of the field of play, the video display extending substantially from one end of the field of play to the second, opposite end of the field of play.

In yet another aspect, the video display is deployed on a playing field of a sporting event venue, an image of the video display being oriented towards grandstands along one of a larger side of the field of play.

In yet another aspect, the pair of video displays is deployed on a playing field of a sporting event venue, an image of a first video display of the pair of video displays being oriented towards grandstands along a first of a larger side of the field of play and an image of a second video display of the pair of video displays being oriented towards grandstands along a second of a larger side of the field of play.

In yet another aspect, the video display is formed in a shape of a stadium (rounded rectangle), wherein an image of the displayed video is oriented on an exterior of the video display.

In yet another aspect, the video display is formed in a shape of a stadium (rounded rectangle) and deployed on a playing field of a sporting event venue, an image of the displayed video being oriented towards grandstands along one of a larger side of the field of play.

In yet another aspect, the video display is deployed along a boundary of the playing field of the sporting event venue, an image of the video display being oriented towards grandstands.

In yet another aspect, the video display is formed in a shape of a stadium (rounded rectangle) and deployed along the boundary of the playing field of the sporting event venue, an image of the displayed video being oriented towards grandstands.

In yet another aspect, the video display is formed in a frustum shape of a stadium (rounded rectangle) with an image of the video being displayed for viewing on an exterior surface.

In yet another aspect, the video display is formed in a frustum shape of a stadium (rounded rectangle) with an image of the video being projected onto an interior surface and displayed for viewing on an exterior surface.

In yet another aspect, the video display is formed in a frustum shape of a stadium (rounded rectangle) and deployed on the playing field of the sporting event venue, an image of the displayed video being oriented towards grandstands.

In yet another aspect, the video display is formed in a frustum shape of a stadium (rounded rectangle) and deployed along the boundary of the playing field of the sporting event venue, an image of the displayed video being oriented towards grandstands.

In yet another aspect, the video display is formed in an enclosed frustum shape of a stadium (rounded rectangle) with an image of the video being projected onto an interior surface and displayed for viewing on an exterior surface.

In yet another aspect, the video display is inflatable and formed in an enclosed frustum shape of a stadium (rounded rectangle) with an image of the video being projected onto an interior surface and displayed for viewing on an exterior surface.

In yet another aspect, the video display is inflatable and formed in an enclosed frustum shape of a stadium (rounded rectangle), the video display being supported by airflow.

In yet another aspect, the video display is inflatable and formed in an enclosed frustum shape of a stadium (rounded rectangle), the video display being supported by airflow and an image of the video being projected onto an interior surface and displayed for viewing on an exterior surface.

In yet another aspect, the video display is inflatable and formed in an enclosed elongated dome shape, the video display being supported by airflow and an image of the video being projected onto an interior surface of the inflatable dome and displayed for viewing on an exterior surface.

In yet another aspect, air flow fans are placed on the playing field, wherein the air flow fans are provided to inflate the dome.

In yet another aspect, air flow fans are placed on the playing field, wherein the air flow fans are provided to inflate the dome, wherein air is fed to the airflow fans from outside of the dome via ducting.

In yet another aspect, the projectors are placed upon the playing field.

In yet another aspect, the projectors are spatially located about the playing field, each projector oriented towards a particular portion of the video screen.

In yet another aspect, the projectors are spatially located about the playing field, each projector oriented towards a particular portion of the inflated video screen.

In yet another aspect, the playing field includes markings for placement of each projector.

In yet another aspect, the playing field includes markings for location of the edge of the video projected by each respective projector.

In yet another aspect, the inflated video screen includes markings for aiding in locating an edge of the video projected by each respective projector.

In yet another aspect, the pair of video displays is deployed along a boundary of a playing field of a sporting event venue, an image of a first video display of the pair of video displays being oriented towards grandstands along a first of a larger side of the field of play and an image of a second video display of the pair of video displays being oriented towards grandstands along a second of a larger side of the field of play.

In yet another aspect, the video display is deployed on a playing field of a sporting event venue of any away team.

In yet another aspect, the video display is deployed on a playing field of a sporting event venue, wherein the sporting event venue is of a type which hosts the same sporting event as the broadcast sporting event.

In yet another aspect, digital images of the players can be generated from digital markers (inertial sensors) located about each respective player.

In yet another aspect, digital images of the players can be generated from digital markers (position identifiers) located about each respective player by recording the player's movements during play.

In yet another aspect, digital images of the players can be generated from digital markers located about each respective player by recording the player's location and movements during play.

In yet another aspect, digital images of the players can be generated from a plurality of fiducials located about each respective player.

In yet another aspect, digital images of the players can be generated from a machine learned model for skeletons for each respective player.

In yet another aspect, digital images of the players can be generated from a computer vision detection algorithm for each respective player. In yet another aspect, the digital images are mapped into a video.

In yet another aspect, the digital images are used to recreate a player's likeness and movements in a form of a hologram.

In yet another aspect, the digital images are used to recreate a player's likeness and movements in a form of a hologram, wherein the hologram is projected onto a different playing field.

In yet another aspect, the digital images are used to recreate a player's likeness and movements in a form of a hologram, wherein the hologram is projected onto a playing field of the away team.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents a schematic view of an exemplary audiovisual sporting event replication system;

FIG. 1A presents a top view of an exemplary camera for use with the audiovisual sporting event replication system originally introduced in FIG. 1, wherein the illustration introduces a blinder for use with each camera;

FIG. 2 presents a top plan view of an audio and video acquisition system in accordance with the present invention deployed within an exemplary sporting events venue, the sporting events venue being where the sporting event is being played;

FIG. 3 presents a side section view of an audience seating arrangement of the exemplary sporting events venue originally introduced in FIG. 2;

FIG. 4 presents a top plan view of an exemplary audio-video playback system in accordance with the present invention deployed at a viewing sporting events venue, the location of the viewing sporting events differs from the location where the sporting event is actually being played;

FIG. 5 presents an isometric view of the exemplary audio-video playback system originally introduced in FIG. 4;

FIG. 6 presents a top plan view of a second exemplary audio and video presentation system deployed at a viewing sporting events venue in accordance with the present invention, the location of the viewing sporting events differs from the location where the sporting event is being played;

FIG. 7 presents an isometric view of the second exemplary audio-video playback system originally introduced in FIG. 6;

FIG. 8 presents an isometric view of a variant of the second the exemplary audio-video playback system originally introduced in FIG. 6, wherein a base of the audio-video playback system is secured to an upper region of playing field boundary defining boards;

FIG. 9 presents an isometric view of a modified variant of the exemplary audio-video playback system originally introduced in FIG. 8, wherein the modified variant of the exemplary audio-video playback system is frustum shaped enabling display of a greater vertical portion (height) of the play;

FIG. 10 presents a cross section elevation view of the exemplary audio-video playback system originally introduced in FIG. 9, the section being taken along section line 10-10 in FIG. 9;

FIG. 11 presents a cross section elevation view of a modified variant of the exemplary audio-video playback system originally introduced in FIG. 10, wherein the modified variant is a completely enclosed dome shaped display system;

FIG. 12 presents a plan view of the exemplary viewing sporting events venue illustrating an exemplary arrangement of components supporting the exemplary audio-video playback system originally introduced in FIG. 11;

FIG. 13 presents an elevation view of an exemplary audio-video playback system deployed upon a stage; and

FIG. 14 presents a perspective view of an exemplary player motion collection system placed upon an exemplary sporting event player.

Like reference numerals refer to like parts throughout the several views of the drawings.

### DETAILED DESCRIPTION

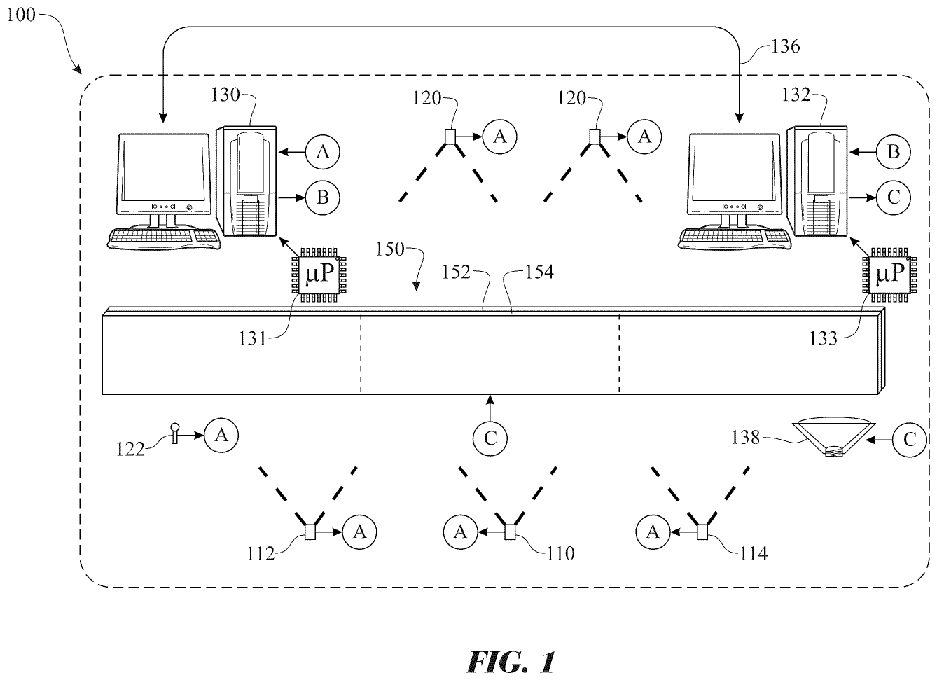

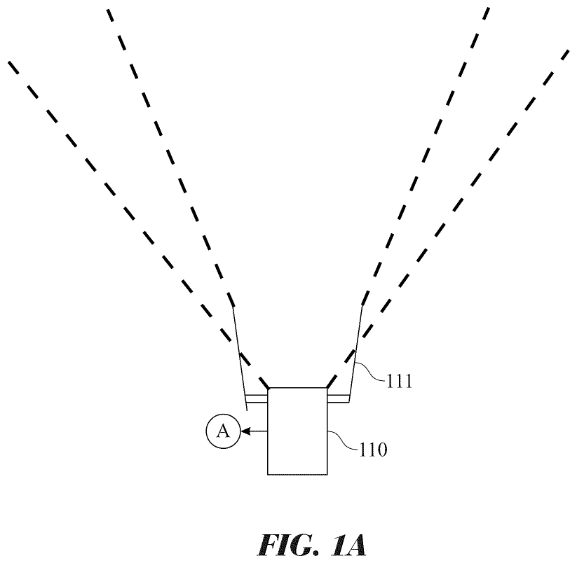

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Sporting events are commonly played in a venue in front of many spectators. Numerous sports are played in a home team—away team arrangement, where the sporting event is played at a venue of the home team. Many fans purchase season tickets and attend a majority or all of the home games, but are limited to watching the away games on television or some other playback device. The video is limited to the video captured by the broadcasting company and is commonly a close up focused on the movement of the playing piece and the activities surrounding the playing piece. Other sporting events occur in a form of a tour, where the spectators would have to travel in order to experience the sporting event at the different venues hosting the sporting events for each stop along the tour.

The present invention provides a system 100, illustrated in schematic form in FIG. 1, which enables the spectators to experience the sporting event at a venue that is closer to their residence or otherwise current location. Video and audio is acquired via one or more video cameras and microphones 110, 112, 114, 120, 122. The one or more video cameras 110, 112, 114, 120 can be of any suitable quality, pixel count, definition level, and the like. Each lens would be selected to optimize the specific application. Each microphone 122 would be selected based upon the location and application at each event.

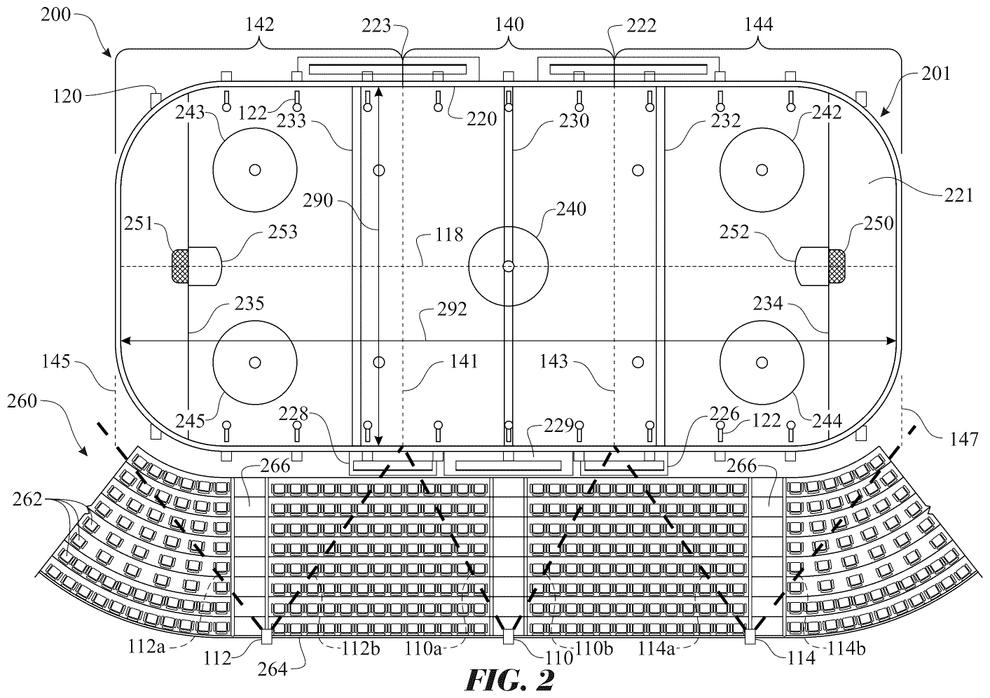

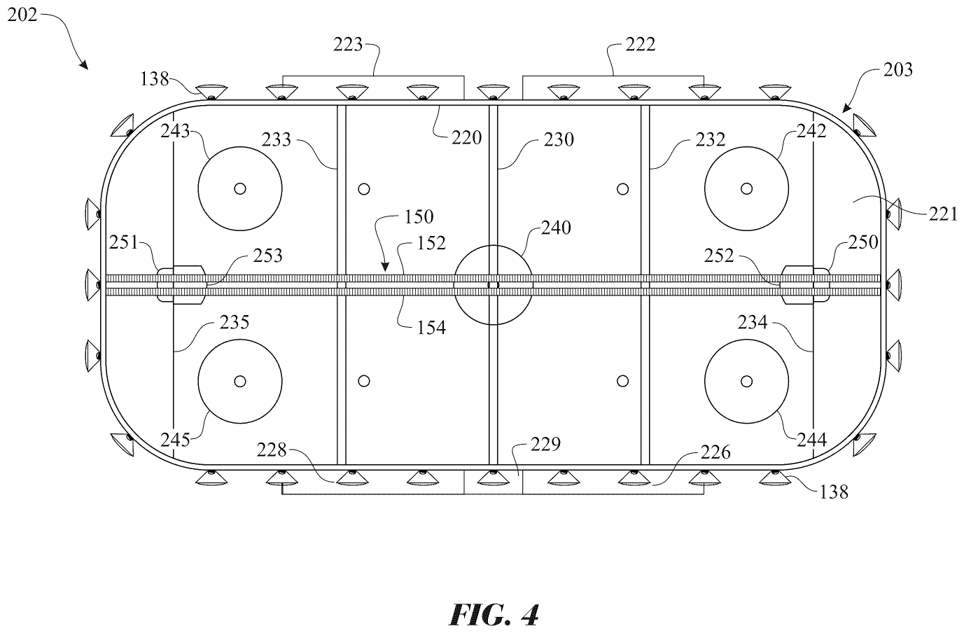

The collected video and audio is processed by a video processing system 130. A video processing system microprocessor 131 of the video processing system 130 operates in accordance with an instruction set stored in a digital memory device. The processing combines the different acquired images into a single video wherein each video image encompasses the entire sporting event at a live venue 200, introduced in FIG. 2. The processed video is then forwarded to a video playback system 132 via a live event—replay location communication link 136. The video playback system 132 provides the audio and video to the audio-video playback system 150, which preferably includes a first audio-video playback system 152 facing a first direction and a second audio-video playback system 154 facing a second, opposite direction. A video playback system microprocessor 133 of the video playback system 132 operates in accordance with an instruction set stored in a digital memory device. The first audio-video playback system 152 and the second audio-video playback system 154 can be a single unit, two units, or multiple units. The audio-video playback system 150 is preferably installed at a viewing sporting event (replay) playing field 203 of the replay venue 202, introduced in FIG. 4, replicating the playing field of the sporting event. In one example, the viewing sporting event (live) playing field/viewing sporting event (replay) playing field 203 of the replay venue 202 is a home venue for the away team of the sporting event.

The display portion of the video to the audio-video playback system 150 can include any of the following:
a projector 192, 194, 196,
a canvas screen 160, 170, 180, 180a,
a upwardly arch-shaped screen 180,
a upwardly arch-shaped display 180,
a dome shaped screen 180a,
a dome shaped display 180a,
a stadium shaped canvas screen 160, 170, 180, 180a,
a stadium shaped display 160, 170, 180, 180a,
a liquid crystal display 150, and
a light emitting diode display 150.

Speakers 138 are preferably located in the replay venue 202 at a position proximate to the position of each respective microphone 122 in the live venue 200 to replicate the location of the originally acquired audio captured by each respective microphone 122.

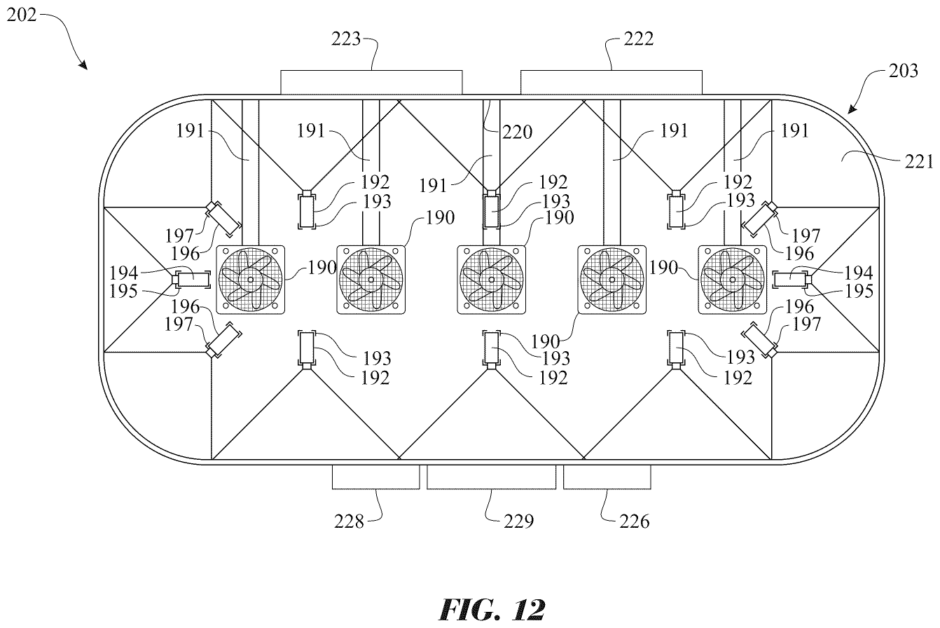

A pair of vertical blinders 111 can be secured to each camera 110, 112, 114, as introduced in FIG. 1A. It would be preferable for each blinder 111 to be adjustably assembled to the respective camera 110, 112, 114, enabling each blinder to be positioned to optimize the view and minimize any overlap of the captured video between two adjacent cameras 110, 112, 114. The blinders 111 can be applied to the projectors (192 illustrated in FIG. 12).

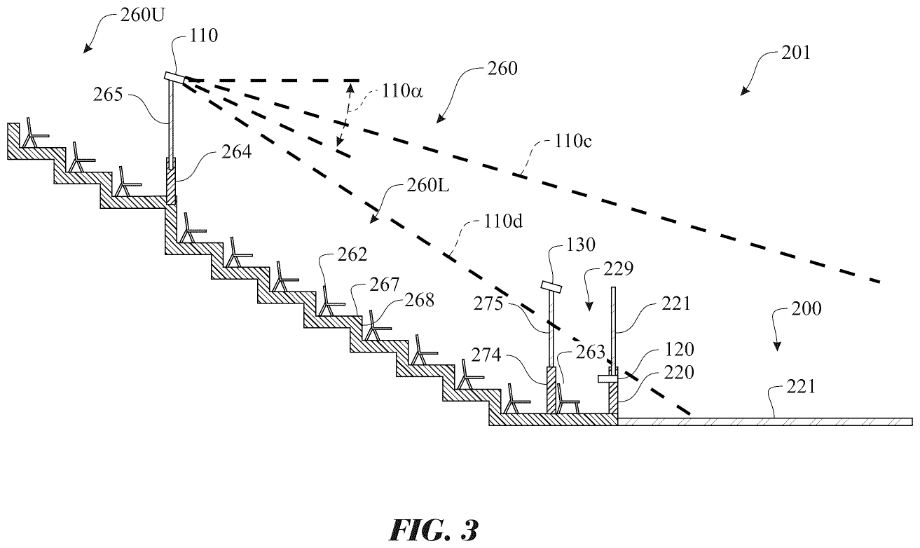

The audio/video acquisition system 110, 112, 114 is deployed within the sporting event (live) playing field 201 of the live venue 200, such as the exemplary illustration presented in FIGS. 2 and 3. The sporting event video transmission system 100 can determine a number of video acquisition segments required to acquire and generate a single video encompassing the entire playing field of the sporting event, such as the exemplary video acquisition segments 140, 142, 144 presented in FIG. 2. The exemplary video acquisition segments 140, 142, 144 are bound by a respective pair of captured video stitch lines 141, 143, 145, 147 located on each side of the respective exemplary video acquisition segment 140, 142, 144. The segments 140, 142, 144 define a minimum width of the playing field at the nearest side as illustrated. Each of the respective sporting event capturing video cameras 110, 112, 114 is located to capture images spanning the minimum width of the playing field for each segment of the stitched video at the nearest side thereof. The location of each of the sporting event capturing video cameras 110, 112, 114 can be determined by a field of view of each respective camera and a distance from the nearest side of the playing field to ensure that each sporting event capturing video cameras 110, 112, 114 captures the entire field of view for each respective segment 140, 142, 144. The field of view of each camera is illustrated by a sporting event capturing video camera first viewing boundary 110a, 112a, 114a, extending along a first side of the field of view of the respective sporting event capturing video camera 110, 112, 114 and a sporting event capturing video camera second viewing boundary 110b, 112b, 114b, extending along a second side of the field of view of the respective sporting event capturing video camera 110, 112, 114.

The sporting event capturing video camera 110, 112, 114 (using the sporting event capturing video camera 110 as the example) also would take into consideration a sporting event capturing video camera upper viewing boundary 110c and a sporting event capturing video camera lower viewing boundary 110d, as illustrated in FIG. 3. The sporting event capturing video camera upper viewing boundary 110c would be of a height to capture the minimum required height of players, etc. on a far side of the playing field boundary (boards) 220. The sporting event capturing video camera 110 is mounted at an angle to captures video of the respective portion of the sporting event on the playing field 220. The angle can be used to angularly compensate for the viewing angle of the sporting event capturing video camera 110 during processing of the captured video.

Each respective sporting event capturing video camera 110, 112, 114 would be located and configured with a focal point being along a sporting event capturing video camera focal point 118, which is located along a midpoint of a playing field width 290. A playing field length 292 is also provided for reference.

The location of each of the sporting event capturing video cameras 110, 112, 114 can also be determined by taking into consideration the shape and features of the venue, the shape of and features of the sporting event (live) playing field, the television production equipment and broadcasters locations, the spectators, the players sideline arrangement, any sideline official's locations, and any other item that might interfere with the acquisition of the video of the sporting event. One exemplary deployment is presented in FIGS. 2 and 3. A plan view of the exemplary deployment is presented in FIG. 2 and an elevation view of the exemplary deployment is presented in FIG. 3.

Lens parameters can be taken into consideration, including intrinsic (e.g., fish-eye) and extrinsic (roll, pitch, yaw, x, y, z). The lens parameters can be addressed using any suitable consideration(s), such as some form of calibration of the system (e.g., how do the cameras know where they are relative to one another), determination of the homography between images such that different images can be warped to fit to a common reference surface, or any other considerations.

Additional considerations can be taken when dealing with overlapping pixels. This can address potential bright spots created by overlapping portions. Therefore overlapping pixels can be addressed using any suitable process, including cropping, adjusting an intensity of the image, and the like. Alternatively, the overlapping pixels can be matched and meshed with like overlapping pixels of an adjacent video effectively stitching the two adjacent segments together. In yet another arrangement, overlapping pixels can be partially (evenly) cropped, leaving each portion as a segment. Each segment can be played upon a respective display of a like number of adjacent displays forming the complete replication video.

In the exemplary illustrations, the sporting event capturing video cameras 110, 112, 114 are located above the glass protection barrier 265 supported by a stands segmenting barrier 264 located between a lower section 260L of seats 262 and an upper section 260U of seats 262 within a spectator grandstands 260. In an alternative arrangement, the sporting event capturing video cameras 110, 112, 114 can be located on posts or any other suitable supporting member. The sporting event capturing video cameras 110, 112, 114 are preferably of a size and installation location that they minimally or avoid any blockage of spectator's view of the sporting event. Additionally, the location of the sporting event capturing video cameras 110, 112, 114 enables an entirely overlapping field of view. One manner to avoid any blockage of spectator's view of the sporting event is to raise the sporting event capturing video cameras 110, 112, 114 to a sufficient height. The proposed exemplary locations of the sporting event capturing video cameras 110, 112, 114 retains as close to a floor level view while locating the sporting event capturing video cameras 110, 112, 114 at an existing location within the venue that avoids both interfering with spectator's views and having spectators, mascots, officials, or other persons within the venue interfere with the acquisition of video of the sporting event.

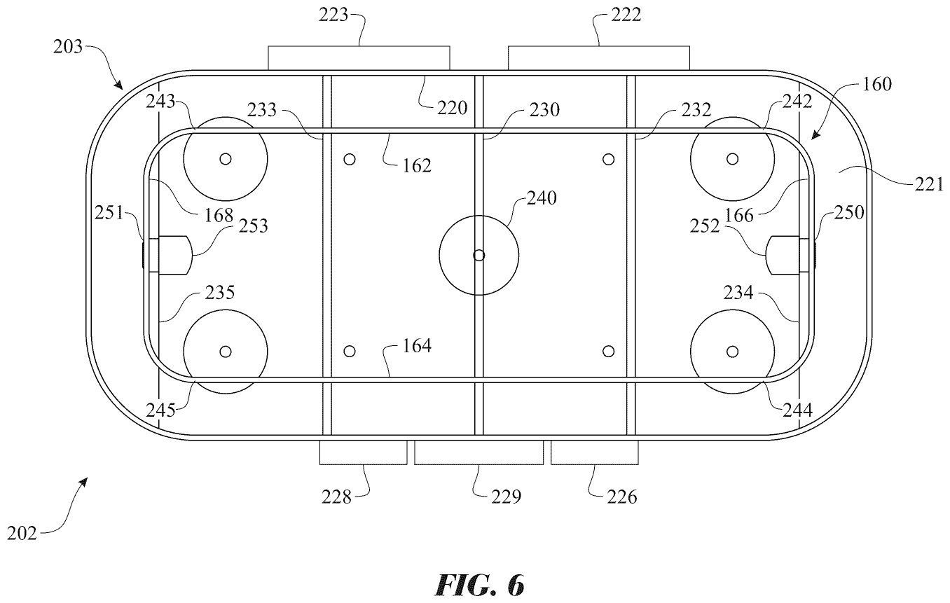

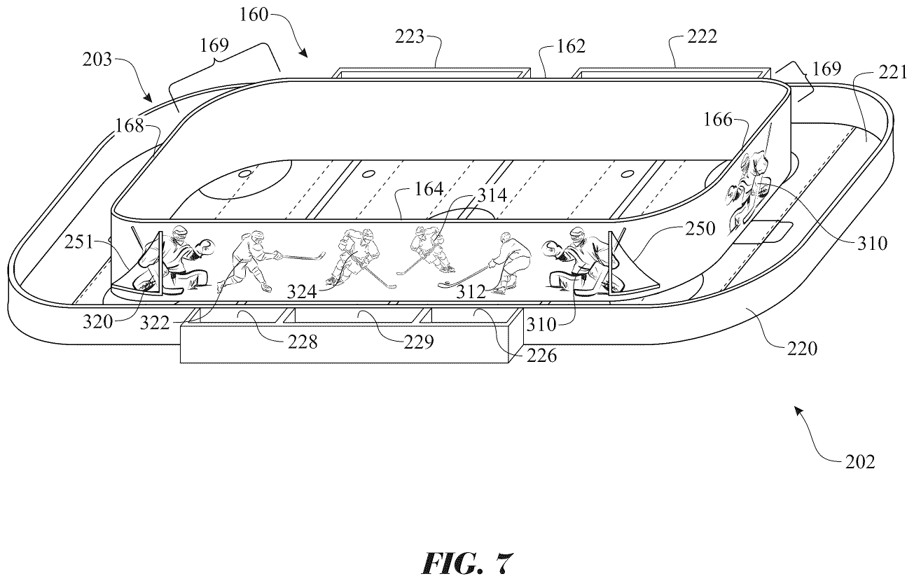

The one or more video cameras and microphones 110, 112, 114, 120 at locations respective to an associated viewing panel. This would place the one or more video cameras and microphones 110, 112, 114, 120 in the spectator grandstands 260 along each of the elongated sides of the sporting event (live) playing field 201 for a linearly arranged viewing playback system 150. Multiple video cameras and microphones 110, 112, 114, 120 would be placed in the spectator grandstands 260 circumscribing the sporting event (live) playing field 201 for a stadium (rounded rectangle) shaped audio-video playback system 160 comprising a first audio-video playback system longitudinal segment 162, a second audio-video playback system longitudinal segment 164, a first audio-video playback system lateral segment 166, and a second audio-video playback system lateral segment 168, as illustrated in FIGS. 6 and 7.

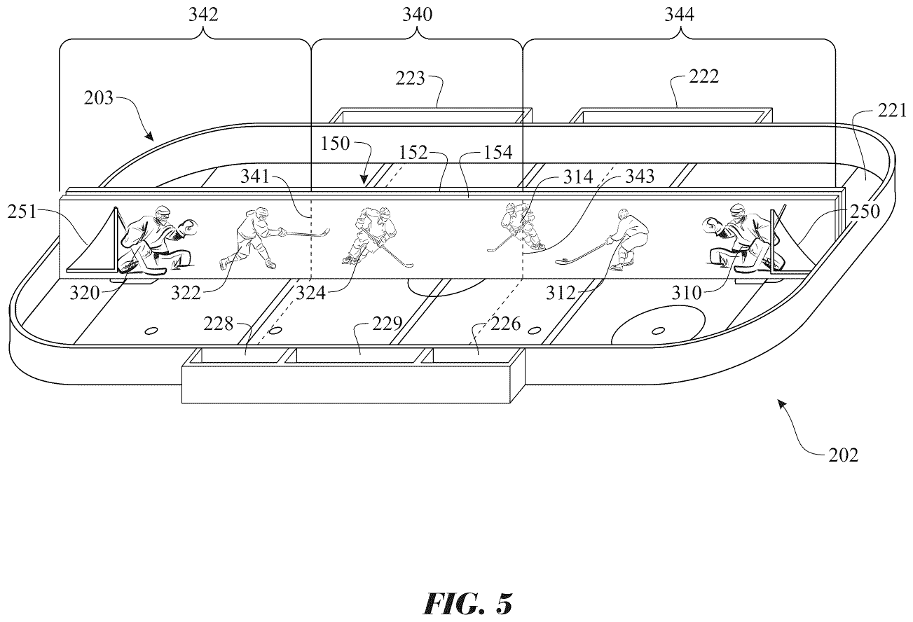

The illustrations present an exemplary sporting event (live) playing field 201 of the live venue 200 in a form of a hockey rink, wherein the sporting event video transmission system 100 is being employed to record an exemplary hockey game being played at the exemplary sporting event (live) playing field 201 of the live venue 200 and the sporting event video transmission system 100 is then employed to replicate audio and video of the exemplary hockey game at a viewing sporting event (live) playing field/viewing sporting event (replay) playing field 203 of the replay venue 202, as illustrated in FIGS. 4 and 5 or in an alternative arrangement in FIGS. 6 and 7.

The illustrations present an exemplary hockey rink as the sporting event (live) playing field. It is understood that the sporting event video transmission system 100 can be utilized at any playing field hosting any sporting event that is suitable for the sporting event video transmission system 100. Examples of suitable sporting events include a football game, a soccer match, a rugby match, a baseball game, a softball game, a basketball game, a hockey game (ice, roller, field, etc.), a lacrosse game, a tennis match, a racket-ball game, a cricket game, a volleyball game, a pickleball game, a badminton game, a polo match, and the like.

The exemplary illustrations present a hockey game being played on a hockey rink. Features of the exemplary hockey rink 201 include a playing field boundary (boards) 220, the exemplary playing field boundary being a rounded rectangle of the boards 220 circumscribing a playing field 221, the exemplary playing field being a layer of ice 221. The exemplary hockey rink 201 is segmented into zones by a playing field centerline 230 extending across a centerline of the rink, a first blue line 232 and a second blue line 233 located equidistant from the playing field centerline 230 towards each end, and a first goal line 234 and a second goal line 235 located parallel to an opening of a respective goal 250, 251. A first end goal crease 252 is located in front of the first end goal 250 and a second end goal crease 253 is located in front of the second end goal 251. The game of hockey includes face-offs. Face-offs occur at different locations about the field of play (ice) 221. A majority of the face-offs occur at specifically marked area that includes a circular dot centered within a larger circle. The exemplary hockey rink 201 includes five (5) face-off locations, including a center ice faceoff circle 240, a first end zone right faceoff circle 242, a second end zone right faceoff circle 243, a first end zone left faceoff circle 244 and a second end zone left faceoff circle 245.

Typical team sports have a portion of the team on the playing field sporting event (live) playing field 201 of the live venue 200 and the remaining players are located on a sideline outside of the playing field. Hockey players are staged on benches. The home team sits on a bench within a home team player's bench 222. The away team sits on a bench within an away team player's bench 223. An optional media area can be located between the home team player's bench 222 and the away team player's bench 223.

The game of hockey includes penalties, wherein when a player is assessed a penalty, the player is placed within a penalty box 226, 228. Officials reside within a game officials (scorekeeper) box 229, the game officials (scorekeeper) box 229 typically being located between the home team penalty box 226 and the away team penalty box 228.

The exemplary illustrations present features of a hockey rink. It is well understood that the playing field for each sporting event differs and would include the respective features for each sporting event. For example, a football game is played at a football stadium including a playing field, yard markers on the playing field, an end zone located at each respective end, a field goal in each end zone, etc. In a second example, a tennis court includes a net, a pair of baselines, a pair of singles sidelines, a pair of doubles sidelines, a pair of service lines, a center service line, optionally an officiating stand, and other features. In a third example, a basketball court includes a basketball court playing surface, a pair of baskets, each basket supported by a respective backboard, a pair of backlines, a pair of free throw lines located within a free throw lane (key), a three point line, a centerline, a pair of sidelines, a center circle, etc. In a fourth example, a soccer field includes a grass covered playing field, a pair of side lines (touchlines), a pair of end-lines (goal-lines), a pair of goals, a pair of goal boxes, a pair of penalty boxes, a halfway line, a center circle, etc. The playing fields and associated features of other sporting events are well known and therefore, not described herein. Sporting event (live) playing fields that are rectangular in shape are optimal for the sporting event video transmission system 100. Baseball diamonds are not optimal, but the sporting event video transmission system 100 can be adapted for use with a game of baseball.

In certain arrangements, the audio/video acquisition systems 110, 112, 114 are located within the spectator grandstands 260. In other arrangements, the audio/video acquisition systems 110, 112, 114 can be located at or proximate ground level, preferably being at a height to tower slightly higher than persons and equipment located on the ground near the audio/video acquisition systems 110, 112, 114. The locations for installation of the audio/video acquisition systems 110, 112, 114 can vary from venue to venue while the considerations are the same. The venue may dictate the number of video acquisition segments 140, 142, 144 based upon the field of view of the video acquisition systems 110, 112, 114 and the distance of the audio/video acquisition systems 110, 112, 114 from the nearest edge of the playing field.

The sporting event is replicated on an audio-video playback system 150 that is temporarily installed on a like playing field located at a different location (the viewing sporting event (live) playing field/viewing sporting event (replay) playing field 203 of the replay venue 202), as illustrated in FIGS. 4 and 5. In the exemplary illustration, the audio-video playback system 150 extends along a length of the playing field. The height of the audio-video playback system 150 can be any suitable height to provide sufficient playback for the respective type of sporting event. The height of the audio-video playback system 150 can vary along a length. For example, an audio-video playback system 150 for basketball will be taller than an audio-video playback system 150 for hockey.

The audio-video playback system 150 can be provided in sections or multiple video display systems for ease of storage and transport. Each video display section can include retractable or locking castors or any other wheel arrangement to aid in transport while providing a system to secure the segment in location. The physical segment length can be the same or independent of the video segment 340, 342, 344 dimensions. A central video playback segment 340 would be between a first central video segment line 341 and a second central video segment line 343. A first outer video playback segment 342 would be displayed between a far edge of the audio-video playback system 150 and the first central video segment line 341. A second outer video playback segment 344 would be displayed between an opposite, far edge of the audio-video playback system 150 and the second central video segment line 343. When using multiple video segment 340, 342, 344, the playback can operate in a manner similar to an extended screen feature when using multiple monitors with a computer.

The audio-video playback system 150 can be of any suitable video playback system, including a Liquid Crystal display, an array of color changing Light Emitting Diodes (LED's), a projection system projecting the video into a screen, or any other suitable video imaging system. The audio playback can utilize the existing sound system installed at the venue. Each of the facing audio-video playback systems 150, 152 can include segments hinged together allowing the entire series of hinged segments to accordion upon one another for portability and storage. Alternatively, the segments can be temporarily assembled to one another using any suitable mechanical assembly interface, such as a pinning system, a clamping system, and the like. The audio-video playback system 150 can include a vertical expansion capability to vertically extending a viewing surface area or to raise the entire audio-video playback system 150 above the surface supporting the system. A cable support system can be employed to provide support and stability to the audio-video playback system 150. The cable support system can be secured to one or more rafters of the structure.

The illustration presented in FIG. 5 includes an exemplary audio-video playback system 150 displaying a hockey game, including images of the 250, the 251, the home team hockey players 310, 312, 314, and the away team hockey players 320, 322, 324. The exemplary players can include goalies 310, 320, defensemen 312, 322, and forwards 314, 324. Other participants can include officials (not illustrated). The illustration presents the exemplary segments 140, 142, 144 of the acquired and broadcast video on the audio-video playback system 150 replicating the actions of the sporting event.

In the exemplary illustration, the audio-video playback system 150 includes a pair of outwardly facing displays visible to the spectators located along the sidelines of the playing field in the viewing sporting event (live) playing field/viewing sporting event (replay) playing field 203 of the replay venue 202. This arrangement reduces the number of spectators that can attend the replicated sporting event, but provides a simplistic system for initial implementation and reduced costs.

An alternative arrangement is presented in FIGS. 6 and 7, wherein the alternative arrangement is provided in a stadium shaped audio-video playback system 160, including a first audio-video playback system longitudinal segment 162, a second audio-video playback system longitudinal segment 164, a first audio-video playback system lateral segment 166, and a second audio-video playback system lateral segment 168, each interconnected with a rounded display. The deployment of the audio/video acquisition systems 110, 112, 114 would be configured to accommodate the rounded rectangle shaped video playback system. This arrangement expands the number of seats having a view of the replicated sporting event. The replicated sporting event would include considerations for the correct viewing angle, including placement of the audio/video acquisition systems 110, 112, 114, processing of the acquired video and playback of the processed video.

The processing of the acquired video can include considerations for homography warping of the image to ensure when projected on the screen the images do not appear to be distorted, mapping of the imaging plane of the camera, distort the acquired image to fit on a surface of rounded displays to avoid an impression of distortion, and the like to the display's surface.

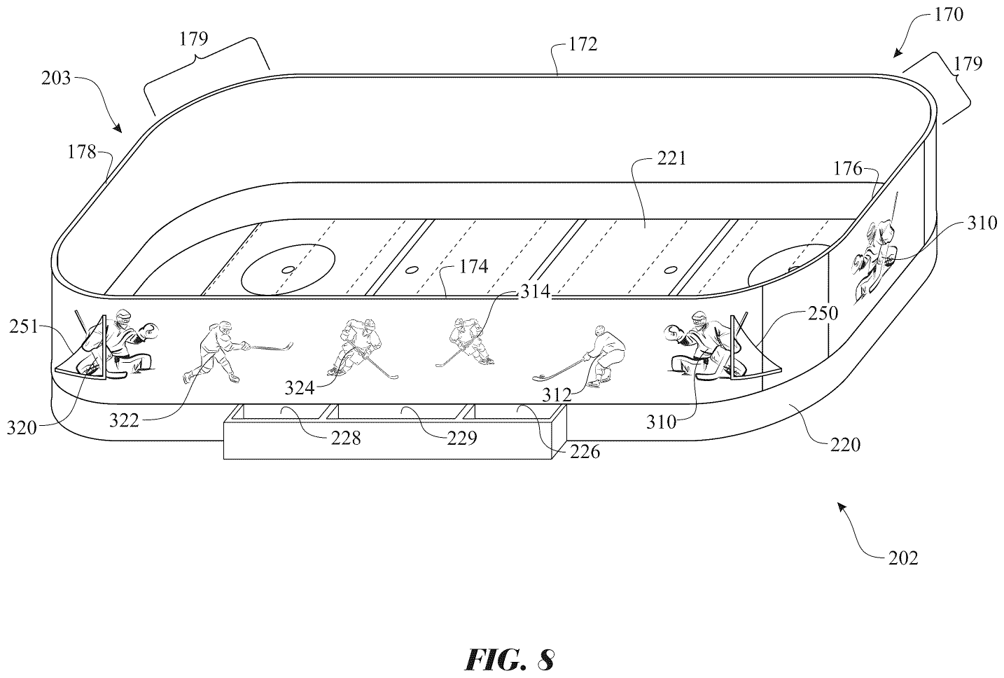

Another alternative arrangement is presented in FIG. 8, wherein the alternative arrangement is provided in a stadium shaped audio-video playback system 170, including a first audio-video playback system longitudinal segment 172, a second audio-video playback system longitudinal segment 174, a first audio-video playback system lateral segment 176, a second audio-video playback system lateral segment 178, and a series of audio-video playback system radial segment 179 connecting each respective audio-video playback system longitudinal segment 172, 174 and each respective audio-video playback system lateral segment 176, 178 with one another, each interconnected with an audio-video playback system radial segment 179. The stadium (rounded rectangle) shaped audio-video playback system 160 is similar to the stadium (rounded rectangle) shaped audio-video playback system 170 wherein the stadium (rounded rectangle) shaped audio-video playback system 170 extends upwards from the playing field boundary (boards) 220. The arrangement of the stadium (rounded rectangle) shaped audio-video playback system 170 provides an enhanced view to the spectators at the viewing sporting event (live) playing field/viewing sporting event (replay) playing field 203 of the replay venue 202 by elevating the viewing area.

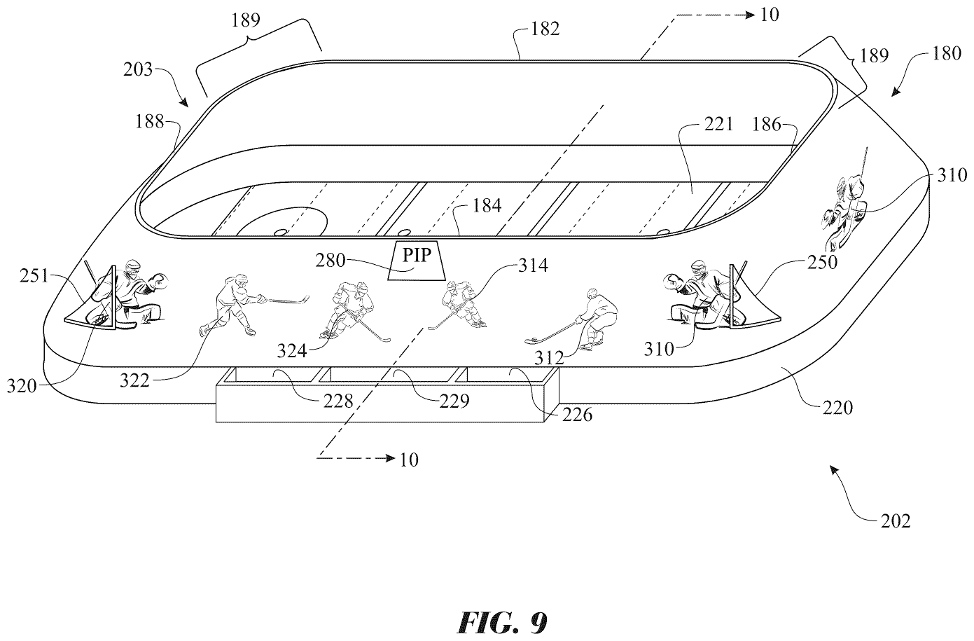

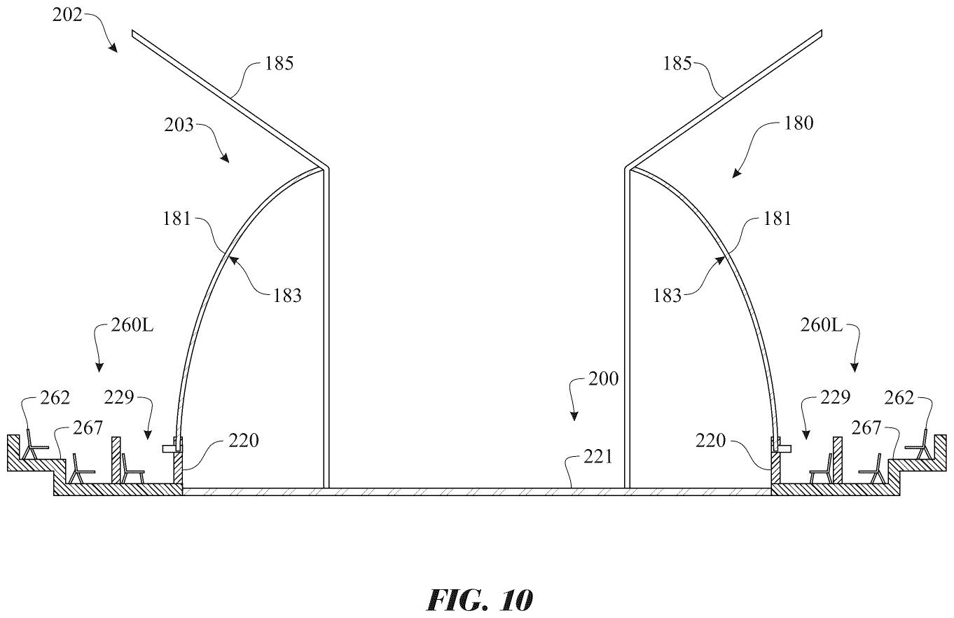

In yet another alternative arrangement, presented in FIGS. 9 and 10, wherein the alternative arrangement is provided in a frustum shaped extruded stadium (rounded rectangle) audio-video playback system 180, including a first audio-video playback system longitudinal segment 182, a second audio-video playback system longitudinal segment 184, a first audio-video playback system lateral segment 186, a second audio-video playback system lateral segment 188, and a series of audio-video playback system radial segment 189 connecting each respective audio-video playback system longitudinal segment 182, 184 and each respective audio-video playback system lateral segment 186, 188 with one another, each interconnected with an audio-video playback system radial segment 189. The arch in a vertical direction (about a horizontal plane) can provide additional video screen without the height and use the arch to create an illusion of extra height. This can be beneficial for sporting events such as basketball, football, tennis or any other sport where the game piece may travel well above the playing field. The frustum shaped extruded stadium (rounded rectangle) audio-video playback system 180 can be fabricated using rigid shaped Light Emitting Diode (LED) panels, Liquid Crystal Display (LCD) panels or any other suitable active display technology. Alternatively, the frustum shaped extruded stadium (rounded rectangle) audio-video playback system 180 can be fabricated of a pliant material, such as a projector screen material. The pliant material would be stretched over and supported by a frame. The frame is designed to be collapsible for transport and storage. The frame can be installed onto the playing field boundary (boards) 220, supported directly upon the floor of the playing field, or supported by any other suitable objection or foundation.

The illustration presented in FIG. 10 additionally introduces a video display shade 185, wherein the video display shade 185 can aid in viewing in an outdoor environment. The video display shade 185 can be applied to any of the embodiments of the displays presented herein.

The system can include a picture in picture display 280, as introduced in FIG. 9, to enable enlarged viewing of specific

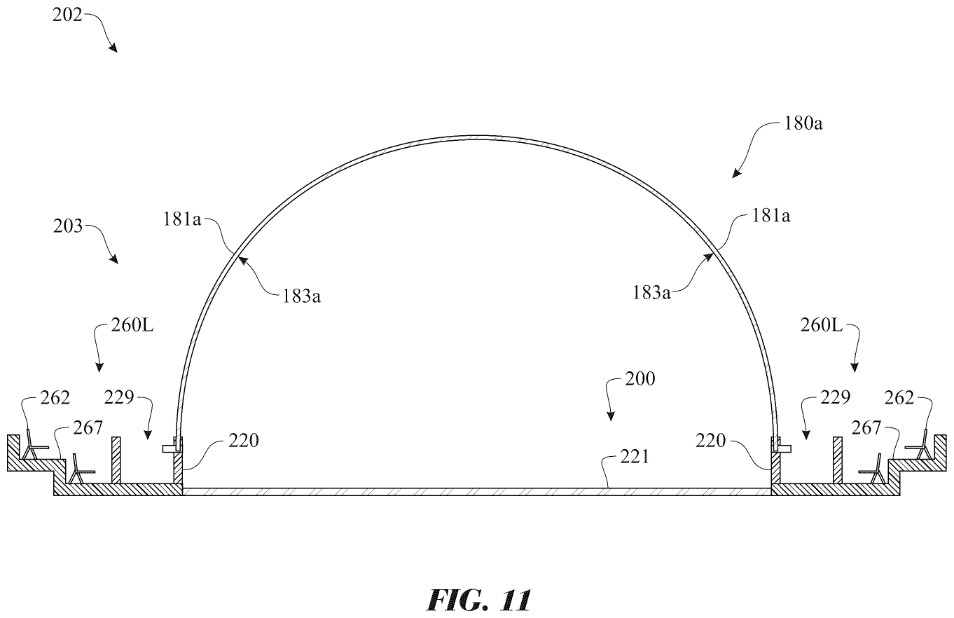

In yet another alternative arrangement, presented in FIG. 11, wherein the alternative arrangement is provided in a dome shaped extruded stadium (rounded rectangle) audio-video playback system 180a. The dome shaped stadium (rounded rectangle) audio-video playback system 180a is an enclosed version of the frustum shaped extruded stadium (rounded rectangle) audio-video playback system 180. One benefit of the dome shaped extruded stadium (rounded rectangle) audio-video playback system 180a being enclosed enables the dome shaped extruded stadium (rounded rectangle) audio-video playback system 180a to be inflatable. The dome shaped stadium (rounded rectangle) audio-video playback system 180a can be fabricated of a thin flexible material, such as a fabric, and inflated in a manner similar to a bounce house by one or more audio-video playback screen inflating fans 190, as illustrated in FIG. 12. The audio-video playback screen inflating fans 190 would be high flow and low noise to provide a desired effect. Air can be supplied to each audio-video playback screen inflating fan 190 via an audio-video playback screen inflating fan ducting 191, wherein each audio-video playback screen inflating fan ducting 191 provides fluid flow between the audio-video playback screen inflating fan 190 and an air source on an exterior of the dome shaped stadium (rounded rectangle) audio-video playback system exterior surface 181a. The quantity and placement of the audio-video playback screen inflating fans 190 would be based upon the design of the system. The use of an inflatable system minimizes or avoids any structural support for the dome shaped extruded stadium (rounded rectangle) audio-video playback system 180a.

The material for the dome shaped stadium (rounded rectangle) audio-video playback system 180a would be selected based upon the method of displaying the video. In one method of displaying the video, the material for the dome shaped stadium (rounded rectangle) audio-video playback system 180a would be a Light Emitting Diode (LED) panel, a Liquid Crystal Display (LCD) panel, or any other variant of self generating display. In a second method of displaying the video, the material for the dome shaped stadium (rounded rectangle) audio-video playback system 180a would a fabric enabling viewing of a projected image. As presented in the exemplary illustrations, the image can be projected onto a dome shaped stadium (rounded rectangle) audio-video playback system interior surface 183a, where the projectors would be spatially placed about the playing field (ice) 221 as illustrated in FIG. 12. The exemplary illustration presents a series of longitudinal segment projectors 192 oriented to project video onto each respective audio-video playback system longitudinal segment 182, 184, at least one lateral segment projector 194 oriented to project video onto each respective audio-video playback system lateral segment 186, 188, and at least one radial segment projector 196 oriented for each audio-video playback system radial segment 189. The projectors 192, 194, 196 are preferably arranged to project video with minimal overlap while avoiding any gaps there between as illustrated. To aid in repeatable set up of the system, the playing field (ice) 221 can be marked with registration or location markings 193, 195, 197 for locating of the projectors 192, 194, 196. Additionally or alternatively, to aid in repeatable set up of the system, the dome shaped stadium (rounded rectangle) audio-video playback system 180a can be marked with registration or location markings 193, 195, 197 for locating of the edges of each of the video images created by the projectors 192, 194, 196.

The arrangement locating the projectors 192, 194, 196 within an interior of the dome shaped stadium (rounded rectangle) audio-video playback system 180a avoids any interference from spectators, employees, objects, or any other potentially interfering object. This arrangement would utilize a video mirroring or inverting process to present a correctly oriented view.

Alternatively, the image can be projected onto a dome shaped stadium (rounded rectangle) audio-video playback system exterior surface 181a, where the projectors would be placed about the viewing sporting event (live) playing field/viewing sporting event (replay) playing field 203 of the replay venue 202 at locations that would minimize any interference from spectators, employees, objects, or any other potentially interfering object.

The frustum shaped extruded stadium (rounded rectangle) audio-video playback system 180 and the dome shaped stadium (rounded rectangle) audio-video playback system 180a can be any display suitable to presenting images using any suitable display generating system. In one example, the frustum shaped extruded stadium (rounded rectangle) audio-video playback system 180 can be fabricated of a series of multi-colored LED's. In another example, the dome shaped stadium (rounded rectangle) audio-video playback system 180a can be fabricated of a translucent or transparent material, wherein the images are projected upon either a dome shaped stadium (rounded rectangle) audio-video playback system exterior surface 181a or a dome shaped stadium (rounded rectangle) audio-video playback system interior surface 183a of the translucent or transparent material.

As previously described for the stadium (rounded rectangle) shaped audio-video playback system 160, the processing of the acquired video can include considerations for homography warping of the image to ensure when projected on the screen the images are not distorted, mapping of the imaging plane of the camera, distort the acquired image to fit on a surface of two dimensional and three dimensionally curved displays stadium (rounded rectangle) shaped audio-video playback system 170, the frustum shaped extruded stadium (rounded rectangle) audio-video playback system 180, and the dome shaped stadium (rounded rectangle) audio-video playback system 180a to avoid distortion, and the like to the display's surface.

The audio-video playback system 150 presented in FIGS. 4 and 5 and the alternative arrangements of the audio-video playback system 160, 170, 180, 180a presented in FIGS. 6 through 12 are preferably installed in a like sporting event venue. The like sporting event venue is preferably an away teams venue, but can be any venue having a like sporting event (live) playing field. Spectators would be seated in the grandstands 260 for viewing of the processed audio and video of the live sporting event. This gathering of spectators can be referred to as a watch party. In a scenario where spectators have season tickets (assigned seats), these spectators can be seated in their season ticket seats and experience the sporting event along with other spectators that commonly sit in the same section, thus adding to the experience. For touring events, such as tennis, the replicated play of the sporting event can be provided at any or multiple venues, preferably those with tennis courts. This can vastly increase exposure to spectators unable to attend the actual event while providing a revenue source for both the sport and the normally vacant venue. Revenue can include entry fees, parking fees, merchandise sales, food and beverage sales, and the like. The experience is significantly different compared to watching broadcasting replay on a jumbotron (jumbovision). The jumbotron at the venue can still be utilized to play broadcast (television) acquired and processed video, which can include commentary, video replays, and the like.

The video system 100 can include a capability of acquiring, then broadcasting, the sporting event using three-dimensional effects. The three-dimensional effects may or may not require special viewing glasses.

The system can employ any or multiple different modalities. For example, stereo cameras, depth cameras, lidar, radar, etc. can be employed to acquire live images of the sporting event. One goal would be to acquired a full 3D representation of the event, wherein the 3D representation of the event can match be matched to 2D video. This enables improved remapping to a different surface if projected accordingly.

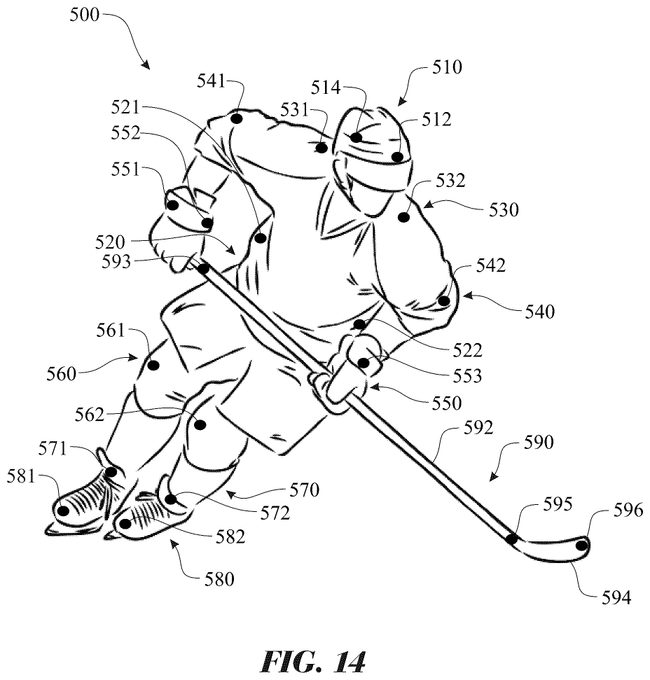

The above embodiments employ video acquisition. The present invention can utilize other technologies to acquire images utilizing full-body motion capture technology to create super-realistic computer-generated (CG) video replicating play of the sporting event. The full-body motion capture technology obtains positioning and motion data of each player 500 by placing any suitable position identifier at key locations on each respective player 500 as well as on any sporting equipment 590, as illustrated in FIG. 14. Examples of suitable position identifier s include inertial sensors, fiducials, and the like. In one alternative, digital images of the players can be generated from a machine learned model for skeletons for each respective player. In another alternative, digital images of the players can be generated from a computer vision detection algorithm for each respective player. The position identifiers are located on the player 500 at key locations to identify movement of the respective anatomical component of the player 500, such as the player's head 510, the player's torso 520, the player's shoulder/upper arm 530, the player's elbow/lower arm 540, the player's hands 550, the player's thigh/upper leg 560, the player's calf/lower leg 570, and the player's feet 580. One or more position identifiers 512, 514 can be secured to the player's head/helmet 510. One or more position identifiers 521, 522 can be secured to the player's torso 520. One or more position identifiers 531, 532 can be secured to the player's shoulder/upper arm 530. One or more position identifiers 541, 542 can be secured to the player's elbow/lower arm 540. One or more position identifiers 551, 552, 553 can be secured to the player's hands 550. One or more position identifiers 561, 562 can be secured to the player's thigh/upper leg 560. One or more position identifiers 571, 572 can be secured to the player's calf/lower leg 570. One or more position identifiers 581, 582 can be secured to the player's feet 580.

The data is collected and processed to create computer generated images of each of the players 500. The computer-generated images of each of the players 500 are overlaid upon a computer generated image of the playing field 201, replicating play of the game into a video. Simultaneously, the process captures audio and combines the audio with the video.

The replicated play of the sporting event can be presented on the audio-video playback system(s) 150, 160, 170, 180 or any other suitable audio-video playback system. In one alternative arrangement, the replicated play of the game can be presented on the viewing sporting event (live) playing field/viewing sporting event (replay) playing field 203 of the replay venue 202 using projected holograms. The holograms would be generated using data collected from the position identifiers or any other known method of generating a three-dimensional image. For example, cameras can be used to capture images of each player. The images are then used to generate the three-dimensional image. The system can use a model of each player in combination with the captured video to generate the three-dimensional images of each player. In another alternative arrangement, the replicated play of the game can be experienced on a virtual headset, wherein a motion of the viewer would change an angle of view of the sporting event on the headset.

The above describes a system that broadcasts the processed audio-video of the sporting event on the audio-video playback system(s) 150, 160, 170, 180 or the alternative audio-video playback system(s) 160, 170, 180. The same processed audio-video of the sporting event can be made available to other locations, such as a stage, a sports bar, a residence, etc. where the processed audio-video of the sporting event can be played upon a properly proportioned television or segmented and played across multiple adjacently located televisions. The processed audio-video of the sporting event can be made available through a subscription.

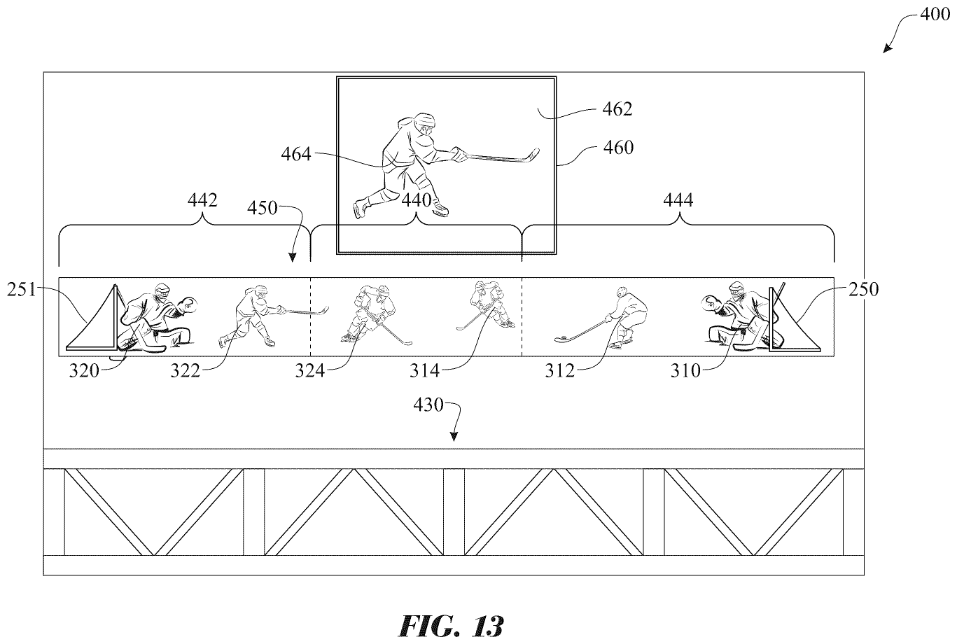

In one example, a stage supporting audio-video playback system arrangement 400 containing an audio-video playback system 450 is illustrated in FIG. 13. The exemplary televised coverage audio-video playback system 460 would be similar to the audio-video playback system 150. The audio-video playback system 450 would be supported by a platform 430, a stand, a wall, scaffolding, cables, or any other means within the stage supporting audio-video playback system arrangement 400. The exemplary audio-video playback system 450 is segmented into a central video segment 440, a first outer video segment 442, and a second outer video segment 444; similar to the audio-video playback system 150. The exemplary video presented upon the audio-video playback system 450 would be the same video as presented upon the audio-video playback system 150, including players 310, 312, 314, 320, 322, 324; goals 250, 251, and other features that are captured on video during play of the sporting event. Additionally, the stage supporting audio-video playback system arrangement 400 can include a televised coverage audio-video playback system 460. A televised coverage audio-video playback system video 464 is presented on a televised coverage audio-video playback system display 462 of the televised coverage audio-video playback system 460.

A similar arrangement can be provided in a sports bar or other establishments using televisions that are adjacent to one another, wherein the adjacent televisions can play the video of the sporting event using the extended monitor function (or other suitable function).

The processed audio-video of the sporting event can also be provided for viewing on a virtual reality headset. This would enable the viewer to view the portion of the game based upon a movement of their head.

Each of these provides the viewer with an ability to view the sporting even as if the viewer were there; independent of any limitations commonly imposed by a broadcasting company. The process can additionally offer replay, allowing the viewer to rewind and replay portions or the entire sporting event. In certain arrangements, the system playing the processed audio-video of the sporting event can include a feature enabling the viewer to zoom in and/or enlarge a region of play such that the viewer can watch details of that portion of the sporting event.

The same technology can be applied to other live performances, such as concerts, plays, musicals, and the like.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

### ELEMENT DESCRIPTION REFERENCES

### Ref. No. Description

100 sporting event video transmission system
110 central sporting event capturing video camera
110a central sporting event capturing video camera first viewing boundary
110b central sporting event capturing video camera second viewing boundary
110c central sporting event capturing video camera upper viewing boundary
110d central sporting event capturing video camera lower viewing boundary
110a sporting event capturing video camera angle from horizontal
112 first outer sporting event capturing video camera
112a first outer sporting event capturing video camera first viewing boundary
112b first outer sporting event capturing video camera second viewing boundary
114 second outer sporting event capturing video camera
114a second outer sporting event capturing video camera first viewing boundary
114b second outer sporting event capturing video camera second viewing boundary
118 sporting event capturing video camera focal point
120 playing field bordering audio video capturing equipment
130 video processing system
131 video processing system microprocessor
132 video playback system
133 video playback system microprocessor
136 live event—replay location communication link
140 central video acquisition segment
142 first outer video acquisition segment
144 second outer video acquisition segment
141 first central captured video stitch line
143 second central captured video stitch line
145 first outer captured video stitch line
147 second outer captured video stitch line
150 audio-video playback system
152 first audio-video playback system
154 second audio-video playback system
160 stadium (rounded rectangle) shaped audio-video playback system
162 first audio-video playback system longitudinal segment
164 second audio-video playback system longitudinal segment
166 first audio-video playback system lateral segment
168 second audio-video playback system lateral segment
169 audio-video playback system radial segment
170 stadium (rounded rectangle) shaped audio-video playback system
172 first audio-video playback system longitudinal segment
174 second audio-video playback system longitudinal segment
176 first audio-video playback system lateral segment
178 second audio-video playback system lateral segment
179 audio-video playback system radial segment
180 frustum shaped extruded stadium (rounded rectangle) audio-video playback system
180a dome shaped stadium (rounded rectangle) audio-video playback system
181 frustum shaped extruded stadium (rounded rectangle) audio-video playback system
exterior surface
181a dome shaped stadium (rounded rectangle) audio-video playback system exterior
surface
182 first audio-video playback system longitudinal segment
183 frustum shaped extruded stadium (rounded rectangle) audio-video playback system
interior surface
183a dome shaped stadium (rounded rectangle) audio-video playback system interior
surface
184 second audio-video playback system longitudinal segment
186 first audio-video playback system lateral segment
188 second audio-video playback system lateral segment
189 audio-video playback system radial segment
190 audio-video playback screen inflating fan
191 audio-video playback screen inflating fan ducting
192 longitudinal segment projector
193 longitudinal segment projector location marker
194 lateral segment projector
195 location marker location marker
196 radial segment projector
197 radial segment projector location marker
200 sporting event (live) playing field
202 viewing sporting event (replay) playing field/venue
220 playing field boundary (boards)
221 playing field (ice)
222 home team player's bench
223 away team player's bench
226 home team penalty box
228 away team penalty box
229 game officials (scorekeeper) box
230 playing field centerline
232 first blue line
233 second blue line
234 first goal line
235 second goal line
240 center ice faceoff circle
242 first end zone right faceoff circle
243 second end zone right faceoff circle
244 first end zone left faceoff circle
245 second end zone left faceoff circle
250 first end goal
251 second end goal
252 first end goal crease
253 second end goal crease
260 spectator grandstands
260L spectator grandstand lower section
260U spectator grandstand upper section
262 fan seat
263 box seat/bench
264 stands segmenting barrier
265 stands segmenting transparent barrier
266 stairway
267 platform section
268 riser section
274 box outer wall
275 box outer wall transparent riser
280 picture in picture display
290 playing field width
292 playing field length
310 home team goalie
320 away team goalie
312 home team defenseman
314 home team forward
322 away team defenseman
324 away team forward
340 central video segment
341 first central video segment line
342 first outer video segment
343 second central video segment line
344 second outer video segment
400 stage supporting audio-video playback system arrangement
440 central video segment
442 first outer video segment
444 second outer video segment
450 audio-video playback system
460 televised coverage audio-video playback system
462 televised coverage audio-video playback system display
464 televised coverage audio-video playback system video
500 motion capture wearing sporting event participant
510 participant's head
512 first head position identifier
514 second head position identifier
520 participant's torso
521 first torso position identifier
522 second torso position identifier
530 participant's shoulder
531 first shoulder position identifier
532 second shoulder position identifier
540 participant's elbow
541 first elbow position identifier
542 second elbow position identifier
550 participant's hand
551 first hand position identifier
552 second hand position identifier
553 third hand position identifier
560 participant's upper leg
561 first upper leg position identifier
562 second upper leg position identifier
570 participant's lower leg
571 first lower leg position identifier
572 second lower leg position identifier
580 participant's foot
581 first foot position identifier
582 second foot position identifier
590 participant's equipment (exemplary hockey stick)
592 participant's equipment first segment (exemplary hockey stick shaft)
593 first equipment position identifier
594 participant's equipment second segment (exemplary hockey stick blade)
595 second equipment position identifier
596 third equipment position identifier

What is claimed is:

1. A system comprising:
at least one camera arranged to capture video, each at least one camera configured to collectively capture play of a sporting event across an entire live event field of play of an event being held in a live venue; and
a video display system configured to display the entire live field of play of the sporting event displaying an entire length of the live event field of play,
wherein the entire event replay field of play is substantially situated within a replay venue and one of (a) similar in size and shape to the entire live event field of play or (b) scaled in size to the entire live event field of play, and
wherein a spectator present during display of video on the video display system at the replay venue is able to view a live sporting event occurring in the live event field of play at the same relative position relative to their location in the replay venue.

2. The system as recited in claim 1, wherein the video display system is configured to display the entire live field of play of the sporting event on a surface substantially coextensive with an entire event replay field of play.

3. The system as recited in claim 1, wherein the sporting event is one of:
a soccer game;
a football game;
a rugby match,
a basketball game;
an ice hockey game;
a roller hockey game;
a field hockey game;
a game of cricket; and
a tennis match.

4. The system as recited in claim 1, further comprising a communication system, wherein the communication system conveys the captured video to a remote location, wherein the entire live field of play of the sporting event is displayed on a remote audio-video playback system during an entire broadcast portion of the sporting event.

5. The system as recited in claim 1, wherein the at least one camera includes multiple cameras spatially arranged along an elongated side of the live event field of play.

6. The system as recited in claim 1, wherein the at least one camera includes multiple cameras spatially arranged around the entire live event field of play.

7. The system as recited in claim 1, further comprising a microprocessor operating in accordance with an instruction set, wherein adjacent videos captured by the multiple cameras are stitched together into a single video image by the microprocessor.

8. The system as recited in claim 1, wherein the video display system employs at least one of:
a projector,
a canvas screen,
a upwardly arch-shaped screen,
a upwardly arch-shaped display,
a dome shaped screen,
a dome shaped display,
a stadium shaped canvas screen,
a stadium shaped display,
a liquid crystal display, and
a light emitting diode display.

9. The system as recited in claim 1, further comprising a plurality of microphones located about the live field of play of the sporting event; and
a plurality of speakers located about the replay field of play at locations proximately replicating placement of the microphones at the live field of play.

10. The system as recited in claim 1, each of the at least one camera further comprising at least one blinder.

11. The system as recited in claim 1, further comprising a shading system, wherein the shading system is designed to shade the video display system.

12. The system as recited in claim 1, wherein the video display system employs at least one projector located on a side of a canvas screen opposite the spectator.

13. The system as recited in claim 1, further comprising a presentation of a broadcast video of the sporting event, wherein the broadcast video of the sporting event is presented on at least one of:
on a jumbotron,
via picture in picture on the video display system, and
on a televised coverage audio-video playback system.

14. The system as recited in claim 1, wherein the video display system employs a dome shaped screen supported by air pressure within the dome shaped screen.

15. The system as recited in claim 1, wherein the video display system displays players of the sporting event in a form of a hologram.

16. A system comprising:
at least one camera arranged to capture video, each at least one camera configured to collectively capture a live event across an entire platform staging the live event at a live venue event; and
a video display system configured to substantially simultaneously display the entire live event at a replay venue,
wherein the entire platform replaying the live event is substantially similar in size and shape to the entire platform staging the live event and situated within the replay venue, and
wherein a spectator present during display of video on the video display system at the replay venue is able to view a live event occurring on the entire platform staging the live event at the same relative position relative to their location in the replay venue.

17. The system as recited in claim 16, wherein the video display system is configured to display the entire live field of play of the sporting event on a surface substantially coextensive with an entire event replay field of play.

18. The system as recited in claim 16, wherein the at least one camera includes multiple cameras spatially arranged in accordance with at least one of:
(a) along an elongated side of the live event field of play, and
(b) around the entire live event field of play.

19. The system as recited in claim 16, further comprising a microprocessor operating in accordance with an instruction set, wherein adjacent videos captured by the multiple cameras are stitched together into a single video image by the microprocessor.

20. The system as recited in claim 16, wherein the video display system employs at least one of:
a projector,
a projector comprising at least one blinder,
a canvas screen,
a upwardly arch-shaped screen,
a upwardly arch-shaped display,
a dome shaped screen,
a dome shaped display,
a stadium shaped canvas screen,
a stadium shaped display,
a liquid crystal display, and
a light emitting diode display.
